(19) United States
(12) Patent Application Publication
(10) Pub. No.: US 2008/0257828 A1
(43) Pub. Date: Oct. 23, 2008

(54) SYSTEMS AND METHODS FOR REDUCTION OF METAL CONTAMINANTS IN FLUIDS

(76) Inventors: Robert L. Kelsey, Fair Oaks Ranch, TX (US); Qiwei Wang, San Antonio, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/737,006

(22) Filed: Apr. 18, 2007

(51) Int. Cl. C02F 1/62; C02F 9/08; C02F 1/52

(52) U.S. Cl. 210/738; 210/259; 210/298; 210/912; 210/702

(57) ABSTRACT

Wastewater steams may include one or more metal contaminants. In various embodiments, a wastewater stream may be sent to a fluid treatment system to reduce the amount of metal contaminants in the wastewater stream. In some embodiments, a fluid treatment system may include a first vortex nozzle unit positioned in an opposed relation to a second vortex nozzle unit. Contacting the wastewater stream exiting the first vortex nozzle unit with the wastewater stream exiting the second vortex nozzle unit may precipitation of one or more metal contaminants in the wastewater steam.

### BACKGROUND

1. Field of the Invention

The present invention relates to the treatment of a fluid to reduce a concentration of metal contaminates in the fluid. More particularly, the invention relates to the reduction of a concentration of metal contaminates in a fluid using a hydrodynamic cavitation system.

2. Brief Description of the Related Art

Commercial processes for the treatment of wastewater containing undesired levels of sulfate and heavy metals include the treatment of the wastewater by filtration, ion exchange, reverse osmosis, and electrodialysis. Wastewater from industrial and mining wastewater systems tend to have high amounts of dissolved minerals and metals present in wastewater. The amount of metals and dissolved solids present in the wastewater streams from some industrial and mining operations may cause problems for the disposal of the wastewater.

Filters used in conventional water treatment processes may become clogged due to the accumulation of metal precipitates in the pores of such filters, rendering the filters ineffective and inoperable. To avoid filtration problems, chelating agents and anti-scalants may be used to complex metal ions, and thereby inhibit the formation of undesired metal compounds such as gypsum and calcium carbonate. Another method to reduce metal concentration in wastewater includes treatment of the wastewater with sulfuric acid. Addition of sulfuric acid, however, may add to the level of sulfate ions in wastewater.

Precipitation of heavy metals by treating wastewater with alkaline compounds, (e.g., treatment of wastewater with sodium hydroxide) is another known technique for removing metal contaminates. Sludge resulting from this treatment, however, may contain a significant amount of water, thus creating disposal problems due to the volume of the sludge.

Various methods to precipitate metals from a solution are described in U.S. Pat. Nos. 6,656,247 to Genik-Sas-Berezowsky et al.; 6,607,651 to Stiller; 6,428,599 to Cashman; 6,361,753 to Cashman; 5,938,892 to Maples et al.; 5,853,535, to Maples et al.; 5,720,882 to Stendahl et al.; 5,709,730 to Cashman; 5,573,738 to Ma et al.; 5,367,116 to Frey; 5,352,332 to Maples et al.; 5,348,662 to Yen et al.; 5,266,210 to McLaughlin; 5,207,910 to Rieber; 5,106,510 to Rieber; and 4,601,780 to Coggins et al.

With the advent of more stringent water disposal requirements, improved systems and methods to reduce a concentration of metal contaminates in one or more fluids are desired.

### SUMMARY

Systems and methods to remove at least a portion of one or more metal contaminates from a fluid are described herein. The fluid may include undesired level of one or more metal contaminates. In some embodiments, an amount of the one or more metal contaminates may be reduced and/or controlled to acceptable parts per million (ppm) and/or part per billion (ppb) levels with or without the use of additives in conjunction with a fluid treatment system.

In some embodiments, the fluid treatment system is coupled to a reservoir. A conduit may couple the reservoir to an inlet of the fluid treatment system. An additional conduit may couple the fluid treatment system back to the reservoir.

A fluid treatment system includes a first vortex nozzle unit and a second vortex nozzle unit positioned opposed to the first vortex nozzle unit. The fluid containing metal contaminates is introduced into the fluid treatment system from the reservoir and/or a separation unit. A first portion of the fluid stream flows through the first vortex nozzle unit and a second portion of the fluid stream flows through the second vortex nozzle unit. The fluid stream exiting the first vortex nozzle unit contacts the second portion of the metal containing fluid stream exiting the second vortex nozzle unit. Contact of the fluid stream exiting the first vortex nozzle unit with the fluid stream exiting the second vortex nozzle unit removes at least a portion of one or more metal contaminates in the fluid. In some embodiments, treatment of the fluid in the fluid treatment system enhances particulate growth and/or precipitation, of the metal contaminates from solution.

During use, at least a portion of the treated fluid exiting the reservoir may be sent to one or more separation units. Separation of the solids from the treated fluid produces a fluid suitable for discharge into receiving bodies, transport to other processing units and/or storage units.

In some embodiments, a fluid treatment system includes one or more vortex nozzle units. Each vortex nozzle unit may include a single pair of vortex nozzles or multiple vortex nozzle units. In some embodiments, a pair opposed vortex nozzle units (a first vortex nozzle and a second vortex nozzle unit). In an embodiment of a fluid treatment system, the first vortex nozzle unit has a plurality of vortex nozzles. When a vortex nozzle unit includes a plurality of vortex nozzles, the vortex nozzles may be arranged in a cascade configuration.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings in which:

FIG. 1 depicts a top view of an embodiment of a fluid treatment system;

FIG. 2 is a cross-sectional view of the fluid treatment system depicted in FIG. 1 taken substantially along line 2-2;

FIG. 3 is a perspective view of a fluid treatment system;

FIG. 4 is a cross-sectional view of the fluid treatment system depicted in FIG. 3 taken substantially along plane 4-4;

FIG. 5 is a perspective view illustrating a vortex nozzle of the apparatus for treating fluids;

FIG. 6 is an alternate perspective view illustrating a vortex nozzle of the apparatus for treating fluids;

FIG. 7 is an end view illustrating an inlet side of a vortex nozzle body of the vortex nozzle;

FIG. 8 is a cross-sectional view of FIG. 5 taken substantially along lines 8-8 illustrating the vortex nozzle body of the vortex nozzle;

FIG. 9 depicts an embodiment of treatment system that includes a fluid treatment, a reservoir and one or more separation units.

FIG. 10 depicts an embodiment of treatment system that includes a fluid treatment system connected to a reservoir.

While the invention is susceptible to various modifications and alternative forms, specific embodiments thereof are shown by way of example in the drawings and will herein be described in detail. The drawings may not be to scale. It should be understood that the drawings and detailed description thereto are not intended to limit the invention to the particular form disclosed, but to the contrary, the intention is to cover all modifications, equivalents and alternatives falling within the spirit and scope of the present invention as defined by the appended claims.

### DETAILED DESCRIPTION

Systems and methods for treatment of a fluid to reduce a concentration of metal contaminates in the fluid are described herein. Selected terms used herein are listed below.

“Fluids” refer to aqueous and/or nonaqueous solutions. Nonaqueous solutions may include organic and/or inorganic compounds. Examples of nonaqueous solutions include, but are not limited to, hydraulic fluids and metalworking fluids; examples of aqueous solutions include, but are not limited to, municipal waste water streams, industrial waste water streams, and mixed waste water streams that contain both soluble and insoluble metal contaminates.

“Metal” refer to one or more metals from Columns 1-13 of the Periodic Table.

“Heavy metals” refers to metal from Columns 3-13 of the Periodic Table. Examples of heavy metals include, but are not limited to, aluminum, arsenic cadmium, chromium, copper, gold, iron, manganese, mercury, nickel, selenium, silver, tin, zinc and lead.

“Periodic Table” refers to the Periodic Table as specified by the International Union of Pure and Applied Chemistry (IUPAC), November 2003.

“Streams” refer to a stream or a combination of streams. The term fluid and/or stream may be used interchangeably.

It is to be understood that the terminology used herein is for the purpose of describing particular embodiments only, and is not intended to be limiting. As used in this specification, the singular forms “a”, “an” and “the” include plural referents unless the content clearly indicates otherwise. Thus, for example, reference to “a nozzle” includes a combination of two or more nozzles and reference to a “metal” and/or “metal contaminates” includes mixtures of different types of metals.

Fluids (e.g., municipal, industrial, commercial, and/or mining wastewater) may include one or more metal contaminates. Some metals (e.g., aluminum, arsenic barium, cadmium, chromium, copper, gold, iron, magnesium, manganese, mercury, nickel, selenium, silver, tin, zinc and/or lead) may be undesirable and/or toxic to humans and animals when introduced into water and/or soil. Removal of undesirable metal contaminates from fluids may involve addition of chemical additives (e.g., sodium hydroxide, calcium hydroxide, lime, calcium oxide, sodium oxide, or mixtures thereof), and/or polymers to aid in precipitation of the undesired metal. Employing the hydrodynamic cavitations and increased hydrodynamic shear feature of the fluid treatment system with chemical additives will enhance, where required particulate growth and/or metal precipitation. Introduction of basic additives may increase the pH of the solution such that undesired metals will form insoluble metal precipitates. The insoluble metal precipitates may form as metal complexes, metal hydroxides, and/or metal oxides. These metal precipitates may be suspended in the fluid, thus making removal of the precipitates ineffective and/or costly. Polymers may be added to increase particle size of the metal precipitate and/or promote coagulation and/or flocculation of the metal precipitates. Increased particle size of the metal precipitate may allow the metal precipitate to more rapidly settle from the fluid.

Once the metals form solids and precipitate from the fluid, the metal precipitates may be removed from the fluid to form a fluid with an acceptable metal concentration. Removal of the metal precipitate from the fluid may include sedimentation and/or filtration methods. For example, an aqueous metal solution may be allowed to stand in a tank to allow the metal precipitate to settle to the bottom of the tank and form sediment. The water may be separated from the sediment, filtered to remove any non-settled metal precipitate, and then be transported to other processing units and/or storage units. Limits for metal concentration in the filtered fluid may range from less than 0.001 mg/l to about 0.25 mg/l or from about 0.005 mg/l to about 0.2 mg/l, or from about 0.05 mg/l to about 0.1 mg/l.

Precipitation of the metals from a fluid containing metal contaminates (metal solution) may require the metal solution to stand for an hour, typically fifteen to forty-five minutes until the desired amount of precipitate has settled. Treatment of the metal solution during the precipitation process in a fluid treatment system may enhance particle growth and/or the rate of precipitation. The rate of precipitation may be enhanced by shifting the chemical equilibrium of the metal ions to favor precipitation. Shifting of the chemical equilibrium may be performed by enhancing dissolution of the basic additives used for precipitation. In some embodiments, treatment of the metal solution may generate small crystals that may enhance particle growth of the metal containing particulates similar to “seeding” a solution to promote crystallization. For example, treatment of an aqueous metal solution with lime in conjunction with a fluid treatment system may increase dissolution of the lime thus allowing more calcium and hydroxide ions to be available for reaction with the undesired metals (e.g., heavy metals). An increase in metal and hydroxide ions may shift the chemical equilibrium to favor precipitation, thus more metal precipitate is formed in less time. Treatment of the metal precipitates in the fluid treatment system may remove liquid from the precipitate, thus increasing the particle size of the metal precipitate (metal containing solid). Increasing the particle size through treatment of the metal solution in a fluid treatment system may increase the efficiency of the precipitation process and/or reduce and/or eliminate the need for addition of polymers.

In some embodiments, the fluid treatment system may be a hydrodynamic cavitation system marketed by VRTX Technologies (Schertz, Tex.). In certain embodiments, a fluid treatment system may be positioned near or adjacent to the precipitation unit.

In certain embodiments, a fluid treatment system includes a first vortex nozzle unit positioned in opposed relationship to a second vortex nozzle unit, and a pressure-equalizing chamber that delivers a flow of a stream to each of the nozzle units. As used herein the term “vortex nozzle unit” refers to a single vortex nozzle or a plurality of vortex nozzles coupled together. The pressure-equalizing chamber receives a stream from a pump and delivers the stream into the first vortex nozzle unit and the second vortex nozzle unit. The first and second vortex nozzle units receive the stream therein and impart rotation to the stream, thereby creating a first rotating stream and a second rotating stream, respectively. The fluid treatment system further includes a collision chamber where impingement of the first rotating stream flow with the second rotating stream flow occurs.

In some embodiments, a fluid treatment system may include two sets of opposed cascaded vortex nozzles. For example, a vortex nozzle unit may include a cascaded vortex nozzle pair, which includes a first vortex nozzle having a second vortex nozzle cascaded within it. The vortex nozzle unit further includes a second cascaded vortex nozzle pair, which includes a third vortex nozzle having a fourth vortex nozzle cascaded within it. More particularly, the outlet from the second nozzle communicates with an inlet into the first nozzle and the outlet from the fourth nozzle communicates with an inlet into the third nozzle. Each of the four vortex nozzles receives a fluid through an inlet that communicates with a stream to impart a rotation to the stream passing through the nozzles. The cascaded vortex nozzles are positioned in opposed relation and communicate with a chamber so that the streams exiting the nozzles rotate in opposite directions to collide at approximately the mid-point of the chamber. The two counter-rotating streams exiting the nozzles collide at high velocity to create a compression wave throughout the fluid.

Hydrodynamic cavitation systems and other fluid treatments systems are described in U.S. Pat. Nos. 4,261,521 to Ashbrook; 4,645,606 to Ashbrook et al.; 4,722,799 to Ashbrook et al.; 4,764,283 to Ashbrook et al.; 4,957,626 to Ashbrook; 5,318,702 to Ashbrook; 5,435,913 to Ashbrook; 6,045,068 to Ashbrook; 6,649,059 to Romanyszyn et al; 6,712,968 to Romanyszyn; 6,797,170 to Romanyszyn; 6,811,698 to Romanyszyn; 6,811,712 to Romanyszyn; and 7,087,178 to Romanyszyn et al.; and U.S. patent application Ser. No. 11/519,986 entitled “SYSTEMS AND METHODS FOR MICROBIOLOGICAL CONTROL IN METAL WORKING FLUIDS” to Kelsey et al., filed Sep. 12, 2006 and U.S. Provisional Patent Application No. 60/901,814 to Kelsey et al., entitled “SYSTEMS AND METHODS FOR TREATMENT OF WASTEWATER” filed Feb. 13, 2007, all of which are herein incorporated by reference.

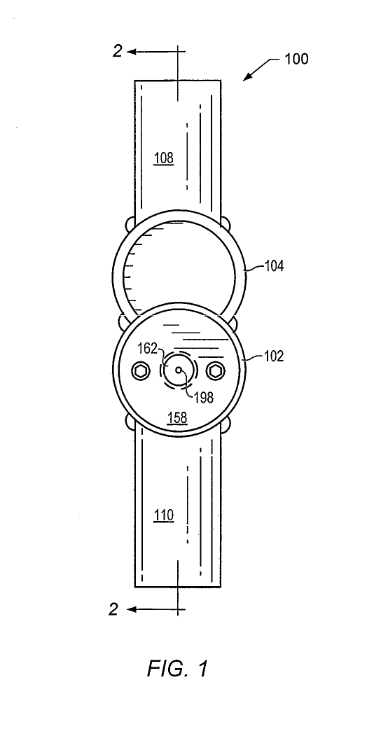

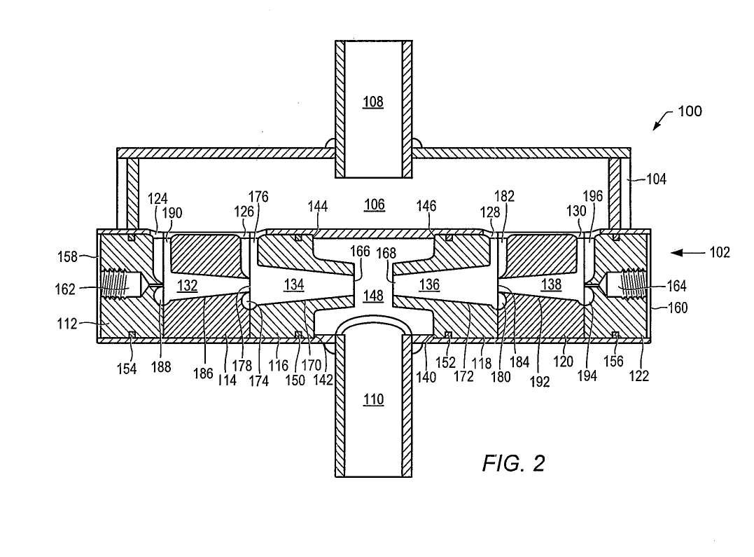

FIGS. 1 and 2 depict an embodiment of a fluid treatment system. Fluid treatment system 100 includes cylindrical body portions 102 and 104 formed integrally using any standard machining or molding process. Cylindrical body portion 104 defines chamber 106 and includes inlet 108 which may be attached to a stream source. Cylindrical body 102 defines a chamber and includes outlet 110 that attaches to any suitable conduit, reservoir, or any suitable fluid delivery means.

Cylindrical body portion 102 houses within its chamber vortex nozzle assembly blocks 112-122 (see FIG. 2). Additionally, cylindrical body 102 includes inlets 124-130 which communicate with chamber 106 of cylindrical body portion 104. The structure of vortex nozzle assembly blocks 112-122 are similar to those described in U.S. Pat. Nos. 4,261,521 to Ashbrook; 4,957,626 to Ashbrook et al., and 5,318,702 to Ashbrook. Each of vortex nozzle assembly blocks 112-122 are shaped using any standard machining or molding process to define a portion of vortex nozzles 132-138. Vortex assembly blocks 112, 114, and 116 define the first vortex nozzle unit and vortex assembly blocks 118, 120, and 122 define the second vortex nozzle unit.

Vortex nozzle assembly blocks 116 and 118 are inserted within the chamber defined by cylindrical body portion 102 until their inner edges contact ledges 140, 142 in body portion 102. Ledges 140, 142 prevent vortex nozzle assembly blocks 116 and 118 from being inserted the center of the chamber defined within cylindrical body portion 102. Vortex nozzle assembly blocks 116 and 118 reside within cylindrical body portion 102 such that they define chamber 148, which communicates with outlet 110. Vortex nozzle assembly blocks 116 and 118 include o-rings 150 and 152, respectively, which form a fluid seal between vortex nozzle assembly blocks 116 and 118 and the inner surface of cylindrical body portion 102.

After the insertion of vortex nozzle assembly blocks 116 and 118 to the position shown in FIG. 2, vortex nozzle assembly blocks 114 and 120 are inserted until they abut the rear portions of vortex nozzle assembly blocks 116 and 118, respectively. Finally, vortex nozzle assembly blocks 112 and 122 are inserted until they abut the rear portions of vortex nozzle assembly blocks 114 and 120, respectively. Vortex nozzle assembly blocks 112 and 122 include o-rings 154 and 156, respectively, which form a fluid seal between vortex nozzle assembly blocks 112 and 122 and the inner surface of cylindrical body portion 102.

Cylindrical body portion 102 includes plates 158 and 160 that fit within the entrances at either end of the cylindrical body portion. Plates 158 and 160 mount over vortex nozzle assembly blocks 112 and 122, respectively, using any suitable means (e.g., screws) to secure vortex nozzle assembly blocks 112-122 with the chamber defined by cylindrical body portion 102.

With vortex nozzle assembly blocks 112-122 positioned and secured within the chamber defined by cylindrical body portion 102, vortex nozzle assembly blocks 112-122 define vortex nozzles 132-138 and conduits 162 and 164. Vortex nozzles 134 and 136 are positioned in opposed relation so that a stream of water exiting their outlets 166 and 168, respectively, will collide approximately at the mid-point of chamber 148. Vortex nozzle assembly blocks 116 and 118 define frustro-conical inner surfaces 170 and 172 of vortex nozzles 134 and 136, respectively. The abutment of vortex nozzle assembly block 116 with vortex nozzle assembly block 114 defines circular portion 174 and channel 176, which communicates with inlet 126. Additionally, outlet 178 from vortex nozzle 132 communicates with circular portion 174 of vortex nozzle 134. Similarly, vortex nozzle blocks 118 and 120 define circular portion 180 and channel 182, which communicates with inlet 128, while outlet 184 from vortex nozzle 138 communicates with circular portion 180 of vortex nozzle 136.

Vortex nozzle assembly block 114 defines frustro-conical inner surface 186, while the abutment between vortex nozzle assembly blocks 112 and 114 defines circular portion 188 and channel 190, which communicates with inlet 124. Vortex nozzle assembly block 120 defines frustro-conical inner surface 192 and the abutment between vortex nozzle assembly blocks 120 and 122 defines circular portion 194 and channel 196, which communicates with inlet 130. Vortex nozzle assembly blocks 112 and 122 include conduits 162 and 164, respectively, which communicate to the exterior of cylindrical body portion 102 via opening 198 in plate 158 (see FIG. 1) and another opening in plate 160 (not shown). Conduits 162 and 164 permit additives to be introduced into vortex nozzles 132-138 during treatment of a fluid.

In operation, fluid is pumped into chamber 106 via inlet 108. The fluid flows from chamber 106 into channels 190, 176, 182, and 196 via inlets 124-130, respectively, of cylindrical body portion 102. Channels 190, 176, 182, and 196 deliver the fluid to circular portions 188, 174, 180, and 194, respectively, of vortex nozzles 132-138. Circular portions 188, 174, 180, and 194 impart a circular rotation to the water and deliver the circularly rotating water streams into frustro-conical inner surfaces 186, 170, 172, and 192, respectively. Frustro-conical inner surfaces 186, 170, 172, 192 maintain the circular rotation in their respective water stream and deliver the circularly rotating water streams to outlets 178, 166, 168, and 184, respectively, from vortex nozzles 132-138.

Due to the cascaded configuration of vortex nozzles 132 and 138, the water streams exiting outlets 178 and 184 enter vortex nozzles 134 and 136, respectively. Those circularly rotating streams combine with the circularly rotating streams within vortex nozzles 134 and 136 to increase the velocity of the circularly rotating streams therein. Additionally, as the streams exiting vortex nozzles 132 and 138 contact the streams within vortex 134 and 136, they strike the circularly rotating streams within vortex nozzles 134 and 136 such that they create compression waves therein.

The combined streams from vortex nozzles 132 and 134 and the combined streams from vortex nozzles 138 and 136 exit vortex nozzles 134 and 136 at outlets 166 and 168, respectively, and collide at approximately the mid-point of chamber 148. The streams are rotating oppositely as they exit vortex nozzles 134 and 136 because vortex nozzles 134 and 136 are positioned in an opposed relationship. As the exiting streams collide, additional compression waves are created which combine with the earlier compression waves to create compression waves having amplitudes greater than the original waves. The recombined water streams exit chamber 148 into outlet 110. The compression waves created by the collision of the exiting streams are sufficient to reduce the interfacial tension in the stream entering inlet 108.

Although the above description depicts a pair of cascaded nozzles, such description has been for exemplary purposes only, and, as will be apparent to those of ordinary skill in the art, any number of vortex nozzles may be used.

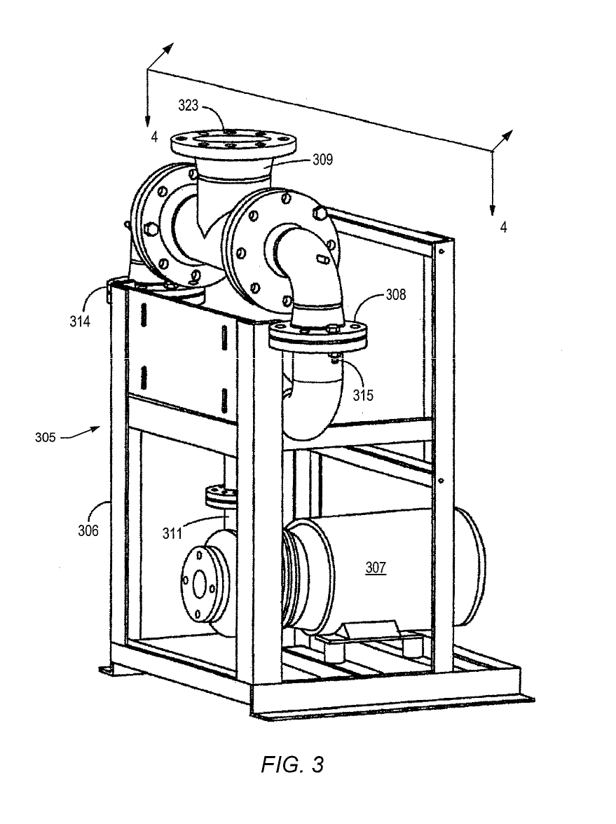

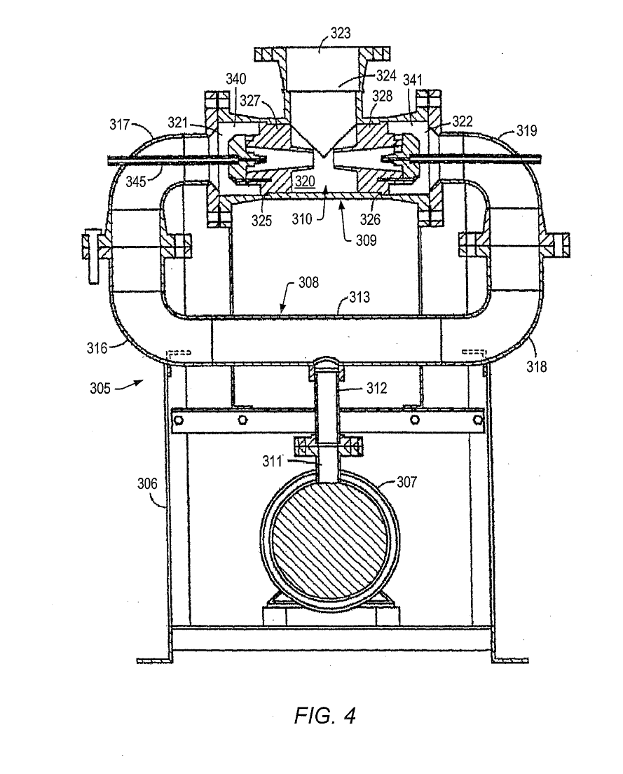

FIGS. 3 and 4 depict an embodiment of a fluid treatment system. Apparatus 305 includes frame 306 for supporting pump 307 and manifold 308. Pump 307 and manifold may be coupled to frame 306 using any suitable coupling means (e.g., brackets). Apparatus 305 may includes housing 309 secured to manifold 308 and vortex nozzle assembly 310. Vortex nozzle assembly 310 is disposed in housing 309.

Pump 307 includes outlet 311 and is any suitable pump capable of pumping fluid from a fluid source through apparatus 305. As shown, pump 307 delivers fluids, those of ordinary skill in the art will recognize many other suitable and equivalent means for delivering fluids, such as pressurized gas canisters may be used.

Manifold 308 includes inlet 312, diverter 313, and elbows 316-319. Inlet 312 couples to outlet 311 of pump 307 using any suitable means (e.g., flange and fasteners) to receive fluid flow from the pump. Inlet 312 fits within an inlet of diverter 313 and is held therein by friction, threading, welding, glue, or the like, to deliver fluid into the diverter. Diverter 313 receives the fluid flow therein and divides the fluid flow into a first fluid flow and a second fluid flow by changing the direction of fluid flow substantially perpendicular relative to the flow from inlet 312. Diverter 313 connects to elbows 316 and 318 by friction, threading, welding, glue, or the like, to deliver the first fluid flow to elbow 317 and the second fluid flow to elbow 319. Elbows 317 and 319 reverses its respective fluid flow received from the diverter 313 to deliver the fluid flow to housing 309. Conduits 345 may pass through portions of elbows 317, 319 to allow for pressure measurements and/or for the introduction of fluid or fluids to the streams entering housing 309. As shown, manifold 308 delivers fluid flow into housing 309, those of ordinary skill in the art will recognize many other suitable and equivalent means, such as two pumps and separate connections to housing 309 or a single pump delivering fluid into side portions of housing 309 instead of end portions.

Housing 309 includes inlets 321, 322, outlet 323, and ledgers 325 and 326. Housing 309 defines bore 320 along its central axis and bore 324 positioned approximately central to the midpoint of housing 309 and communicating with bore 320. Housing 309 is attached to elbows 317 and 319, using any suitable means, such as flanges and fasteners. Housing 309 receives a first fluid flow at inlet 321 and a second fluid flow at inlet 322. Outlet 323 is connectable to any suitable fluid storage or delivery system using well-known piping means.

Vortex nozzle assembly 310 resides within bore 320 and, in one embodiment, includes vortex nozzles 327 and 328, which are positioned within bore 320 of housing 309 in opposed relationship to impinge the first fluid flow with the second fluid flow, thereby treating the flowing fluid. With vortex nozzle 327 inserted into housing 309, vortex nozzle 327 and housing 309 define cavity 340, which receives the first fluid flow from elbow 317 and delivers the first fluid flow to vortex nozzle 327. Similarly, with vortex nozzle 328 inserted into housing 309, vortex nozzle 328 and housing 309 define cavity 341, which receives the second fluid flow from elbow 319 and delivers the second fluid flow to vortex nozzle 328.

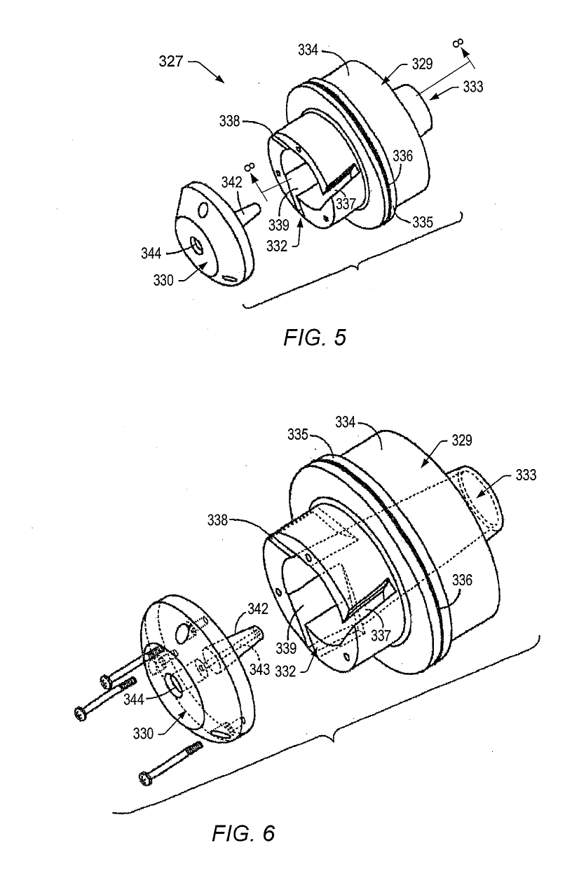

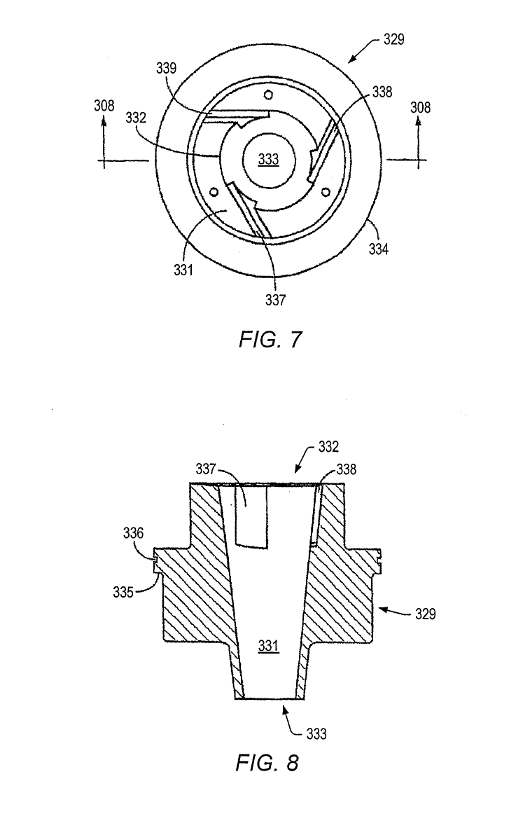

As illustrated in FIGS. 5-8, vortex nozzle 327 includes nozzle body 329 and end cap 330. For the purposes of disclosure, only vortex nozzle 327 will be described herein, however, it should be understood that vortex nozzle 328 may be identical in design, construction, and operation to vortex nozzle 327 and merely positioned within bore 320 of housing 309 in opposed relationship to vortex nozzle 327 to facilitate impingement of the second fluid flow with the first fluid flow.

Nozzle body 329, in one embodiment, is substantially cylindrical in shape and includes tapered passageway 331 located axially therethrough. The tapered passageway 331 includes inlet side 332 and decreases in diameter until terminating at an outlet side 333. The taper of the tapered passageway 331 is at least 1° and at most 90°. In some embodiments, the taper of the tapered passageway is at least 5° and at most 60°.

Nozzle body 329 includes shoulder 334 having raised portion 335 with groove 336 therein. Shoulder 334 is sized to frictionally engage vortex nozzle 327 with an interior surface of housing 309, while raised portion 335 of the vortex nozzle abuts ledge 325, thereby controlling the position of vortex nozzle 327 within the housing 309. Groove 336 receives a seal as o-ring to seal nozzle body 329 with housing 309 and, thus, vortex nozzle 327 within housing 309.

Nozzle body 329 further includes ports 337-339 for introducing fluid into tapered passageway 331 of vortex nozzle 327. As shown, ports 337-339 may be equally spaced radially about the nozzle body 329 beginning at inlet side 332. Although three ports 337-339 are shown, those of ordinary skill in the art will recognize that any number of ports may be utilized. Furthermore, ports 337-339 may be any shape suitable to deliver fluid into the tapered passageway 331, such as elliptical, triangular, D-shaped, and the like.

As shown, ports 337-339 are tangential to the inner surface of tapered passageway 331 and enter tapered passageway 331 at the same angle as the taper of the tapered passageway, which enhances the delivery of the fluid into tapered passageway 331 and, ultimately, the distribution of the fluid around the tapered passageway. Although tangential ports 337-339 are shown as being angled with the taper of the tapered passageway 331, those of ordinary skill in the art will recognize that the ports 337-339 may enter tapered passageway 331 at any angle relative to the taper of the tapered passageway 331.

End cap 330 abuts the end of nozzle body 329, defining inlet side 332, to seal inlet side 332, and thereby permitting fluid to enter into the tapered passageway 331 through ports 337-339. End cap 330 may include boss 342 formed integrally therewith or attached thereto at approximately the center of the inner face of the end cap. In this embodiment, the boss 342 is conical in shape and extends into tapered passageway 331 to adjust the force vector components of the fluid entering tapered passageway 331. Passageway 343 through boss 342 communicates with cavity 344 at approximately the center of the outer face of end cap 330. Conduit 345 (see FIG. 4) fits within cavity 344 to permit measurement of a vacuum within tapered passageway 331.

A flow of fluid delivered to vortex nozzle 327 enters tapered passageway 331 via ports 337-339. The entry of fluid through ports 337-339 imparts a rotation to the fluid, thereby creating a rotating fluid flow that travels down tapered passageway 331 and exits outlet side 333. Each port 337-339 delivers a portion of the fluid flow to tapered passageway 331. The flow may be in multiple bands that are distributed uniformly in thin rotating films about tapered passageway 331. This minimizes pressure losses due to internal turbulent motion. Accordingly, vortex nozzle 327 provides for a more intense and stable impact of rotating fluid flow exiting outlet side 333 of tapered passageway 331 with fluid exiting vortex nozzle 328.

In some embodiments, a cross-sectional area of ports 337-339 is less than the cross-sectional area of inlet side 332 of tapered passageway 331, which creates a reduced pressure within the rotating fluid flow. It should be understood to those of ordinary skill in the art that the size of ports 337-339 may be varied based upon particular application requirements. The amount of vacuum created by ports 337-339 may be adjusted utilizing boss 342 to alter the force vectors of the rotating fluid flow. Illustratively, increasing the size of boss 342 (e.g., either diameter or length) decreases the volume within the tapered passageway 331 fillable with fluid, thereby increasing the vacuum and, thus, providing the rotating fluid flow with more downward and outward force vector components.

In operation, manifold 308 is assembled as previously described and connected to pump 307. Vortex nozzles 327 and 328 are inserted in opposed relationship into housing 309 as previously described, and housing 309 is connected to manifold 308. Pump 307 pumps fluid from a fluid source and delivers the fluid into manifold 308, which divides the fluid into a first fluid flow and a second fluid flow. Manifold 308 delivers the first fluid flow into cavity 340 of housing 309 and the second fluid flow into cavity 341 of housing 309. The first fluid flow enters vortex nozzle 327 from cavity 340 via the ports of vortex nozzle 327. Vortex nozzle 327 receives the fluid therein and imparts rotation to the fluid, thereby creating a first rotating fluid flow that travels down vortex nozzle 327 and exits its outlet side. Similarly, the second fluid flow enters vortex nozzle 328 from cavity 341 via the ports of vortex nozzle 328. Vortex nozzle 328 receives the fluid therein and imparts rotation to the fluid, thereby creating a second rotating fluid flow that travels down vortex nozzle 328 and exits its outlet side. Due to the opposed relationship of vortex nozzles 327 and 328, the first rotating fluid flow impinges the second rotating fluid flow, resulting in the treatment of the fluid through the breaking of molecular bonding in the fluid and/or the reduction in size of solid particulates within the fluid. The treated fluid then exits outlet 323 of housing 309 and travels to a suitable fluid storage or delivery system.

In some embodiments, the pressure of the stream in a vortex nozzle unit may be in the range of approximately 50 pounds per square inch (psi) to approximately 200 psi, approximately 80 psi to approximately 140 psi, or approximately 85 psi to approximately 120 psi. The stream may flow into a fluid treatment system at a flow rate of 1500 gallons per minute or less. In certain embodiments, a stream may flow into a fluid treatment unit at a flow rate of approximately 70 gallons to approximately 200 gallons per minute.

Fluid and cavitation bubbles may initially encounter a region of higher pressure when entering one or more of the vortex nozzle units in the system and encounter a vacuum area, at which point vapor condensation occurs within the bubbles and the bubbles collapse. The collapse of cavitation bubbles may cause hydrodynamic cavitations and pressure impulses. In some embodiments, the pressure impulses within the collapsing cavities and bubbles may be on the order of up to 1000 lbs/in². Hydrodynamic cavitation and/or other forces exerted on the fluid (e.g., pressure impulse, side walls of the nozzles) may cause changes in solubility of dissolved gasses, pH changes, formation of free radicals, and/or precipitation of metal ions such as metal phosphates, metal nitrates, metal oxides, metal hydroxides, metal carbonates, metal sulfates, or mixtures thereof.

In some embodiments, basic additives (e.g., calcium oxide) may be introduced to a fluid to enhance precipitation of metals from the fluid. The fluid may be passed through the fluid treatment system. A number of passes may range from 1 to 100, from 5 to 50, or from 10 to 30. In some embodiments, one to five passes are need to reduce a level of metal contaminates in the fluid. For example, wastewater from a coal mining operation was treated with lime and passed through the fluid treatment system one time. The metal ion concentration in the treated water was determined before and after the fluid was treated with the fluid treatment system using atomic absorption analytical methods or ion coupled plasma analytical methods. Samples were taken prior to and after fluid treatment. As shown in TABLE 1, the treatment of the water solution resulted in at least 90% removal of the heavy metals from the coal mine wastewater.

TABLE 1

| | Metal | | |
|---|---|---|---|
| | Concentration, | Metal Concentration after | Percent Reduction in |
| Metal | Initial (ppm) | treatment, ppm | Metal Concentration |
| Al | 6.58 | 0.18 | 97% |
| Fe | 11.8 | 0.25 | 97.9% |
| Mn | 4.7 | 0.24 | 94.9% |
| Zn | 0.23 | 0.02 | 91.3% |

TABLES 2 and 3 depict additional experiments for treating of coal mine wastewater to reduce the concentration of heavy metals in the water.

TABLE 2

| | Metal | Metal | |
|---|---|---|---|
| | Concentration, | Concentration after | Percent Reduction in |
| Metal | Initial (ppm) | treatment, ppm | Metal Concentration |
| Al | 0.32 | 0.08 | 75.0% |
| Cu | 0.021 | 0.001 | 95.2% |
| Mn | 0.758 | 0.001 | 99.9% |
| Cd | 0.002 | <0.001 | 95.0% |

TABLE 3

| | Metal | | |
|---|---|---|---|
| | Concentration, | Metal Concentration after | Percent Reduction in |
| Metal | Initial (ppm) | treatment, ppb | Metal Concentration |
| Al | 4.68 | 0.15 | 96.8 |
| Fe | 1.0 | 0.2 | 80.0 |
| Mn | 2.0 | 0.01 | 99.5 |
| Pb | 0.002 | <0.001 | 95.0% |

In some embodiments, the system may be monitored and/or adjustments made as needed to control the metal ion concentration in the fluid. For example, the concentration of metal ions may be monitored continuously or periodically. Monitoring the concentration of metal ions continuously or periodically may allow for the adjustment of flow rates, number of recycles through the system, and/or the amount and/or type of additive introduced into the system so that the concentration of metal ions in the stream exiting the fluid treatment system is at or below a desired level.

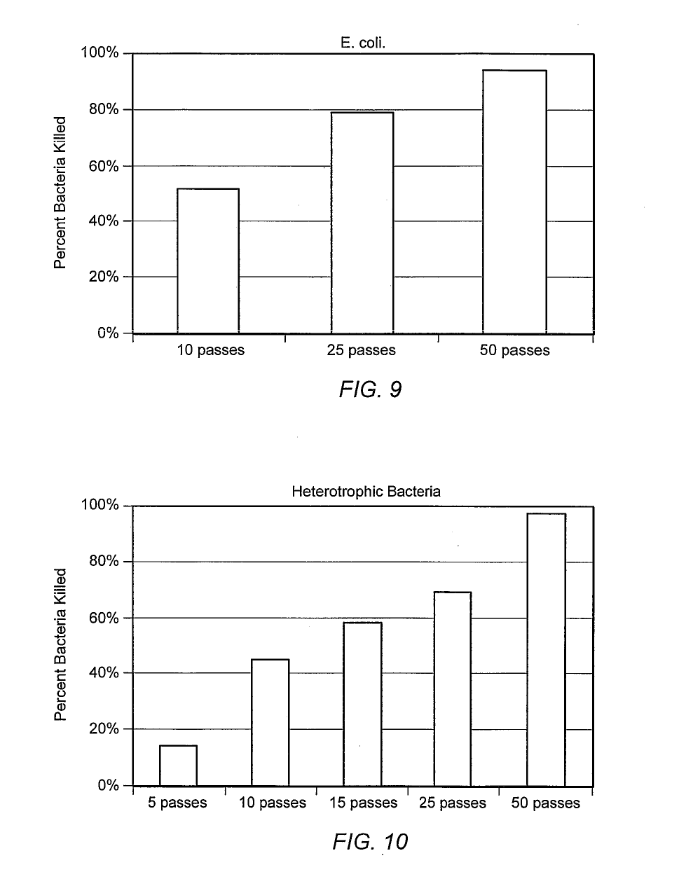

In some embodiments, treatment system 400 includes a reservoir 402 (e.g., reaction tank), separation unit 416 and 418, and a fluid treatment system 100. Fluid treatment system 100 may be coupled to the reservoir 402. As depicted in FIG. 9, reservoir 402 receives fluid (e.g., municipal waster water, industrial waste water, mine wastewater and/or commercial wastewater containing heavy metals) via conduit 404. Additives (e.g., lime, calcium oxide, calcium hydroxide, sodium hydroxide or mixtures thereof) may be added to conduit 404 via additive conduit 406. Conduit 404 may include an inline mixer to aid in the dissolution of the additive into fluid. In some embodiments, the additive is mixed with the fluid in a separate unit and then transported to reservoir 402 via conduit 404.

Conduit 408 may couple the reservoir to an inlet of fluid treatment system 100. Additional conduit 410 may couple the fluid treatment system back to the reservoir. During use, at least a portion of the fluid exiting the fluid treatment system may be recycled back into the fluid treatment system, rather than being sent to the reservoir or distributed to other processing units. Recycle conduit 412 may be coupled to exit conduit 438 to allow the fluid to be recycled. A three-way valve may be positioned at the intersection of conduits 410 and 412 to control the flow of the fluid. In some embodiments, recycle conduit 412 is not needed.

Treated fluid may exit reservoir 402 via conduit 414 to separation unit 416 (e.g., a holding tank). In separation unit 414, the treated fluid may stand in separation unit 414 to allow the metal precipitates formed in reservoir 402 to gravitationally separate and form a liquid phase and a sediment phase. An amount of time the fluid is held may depend on the amount of metal contaminates in the fluid. For example, for fluids having a high concentration of metal contaminants may have a longer standing time than solutions having a minimal amount of metal contaminants. In some embodiments, the metal precipitates may be separated to from the liquid phase using known sedimentation separation techniques (e.g., centrifugal separator and/or gravity). As the metal precipitates are separating, the particle size of the metal precipitate may increase. Treatment of the fluid with fluid treatment system 100 may enhance the particle size growth and/or the rate of separation. The fluid from separation unit 414 may enter separation unit 416 via conduit 418. Solid particulates may be removed using generally known filtration methods (e.g., centrifugal separator, gravity, filter bag, screen, medium filters, or combinations thereof). The filtered fluid may exit separation unit 416 via conduit 420 and be transported to other processing units and/or storage units and/or discharged into one or more receiving bodies. In some embodiments, separation unit 414 and 416 are one unit.

In some embodiments, the fluid treatment system is coupled to a reservoir. Addition of basic additives to the fluid treatment system may increase the rate of particle growth (solids) formation and/or settling rate of metal contaminates. Treating the metal solution in the fluid treatment system may reduce the number of reservoirs and/or separation units currently used to treat fluids containing metal contaminates.

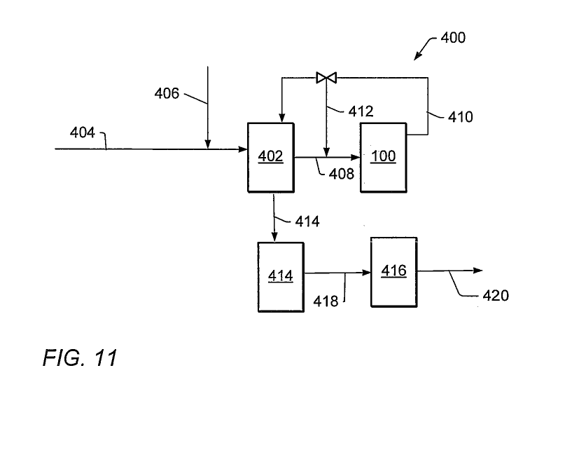

As shown in FIG. 10, treatment system 430 includes a reservoir fluid treatment system 100 coupled to reservoir 432 (for example, a separation unit similar to separation unit 416). Fluid treatment system 100 receives fluid (e.g., municipal waster water, industrial waste water, mine wastewater and/or commercial wastewater containing heavy metals) via conduit 434. Additives (e.g., lime, calcium oxide, calcium hydroxide, sodium hydroxide or mixtures thereof) may be added to conduit 434 via additive conduit 436. Conduit 434 may include an inline mixer to aid in the dissolution of the additive into fluid. In some embodiments, the additive is mixed with the fluid in a separate unit and then transported to reservoir 432 and/or fluid treatment system 100. In certain embodiments, additives are added directly to fluid treatment system through additive conduit 436.

Conduit 438 may couple the reservoir to an inlet of fluid treatment system 100. Additional conduit 440 may couple the fluid treatment system back to the reservoir. During use, at least a portion of the fluid exiting the fluid treatment system may be recycled back into the fluid treatment system, rather than being sent to the separation unit or distributed to other processing units. Treatment of the fluid with fluid treatment system 100 may enhance the particle size growth and/or the rate of separation. Recycle conduit 442 may be coupled to exit conduit 438 to allow the fluid to be recycled. A three-way valve may be positioned at the intersection of conduits 440 and 442 to control the flow of the fluid. In some embodiments, recycle conduit 442 is not needed.

Treated fluid may exit reservoir 432 via conduit 444 to separation unit 446. In separation unit 446, solid particulates may be removed from the fluid using generally known filtration methods (e.g., centrifugal separator, gravity, filter bag, screen, medium filters, or combinations thereof). The filtered fluid may exit separation unit 446 via conduit 448 and be transported to other processing units and/or storage units and/or discharged into one or more receiving bodies. In some embodiments, separation unit 446 includes more than one separation unit.

In an embodiment, the concentration of metal ions in the fluid may be assessed prior to introducing the fluid into the fluid treatment system. For example, a sample from reservoir 402, reservoir 432, fluid treatment system 100, or combinations thereof may be removed and tested for metal ions. Alternatively, in-line monitoring equipment may be coupled to conduit 408, conduit 410, conduit 440, and/or conduit 438 to allow continuous monitoring of the metal ion concentration in reservoir 402, reservoir 432, and/or fluid treatment system 100. Once a concentration of metal ions is assessed, a number of passes through the fluid treatment system may be estimated and/or a concentration of additives may be added to reservoir 402, reservoir 432, and/or fluid treatment system 100.

In this patent, certain U.S. patents and other materials (e.g., articles) have been incorporated by reference. The text of such U.S. patents and other materials is, however, only incorporated by reference to the extent that no conflict exists between such text and the other statements and drawings set forth herein. In the event of such conflict, then any such conflicting text in such incorporated by reference U.S. patents and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A treatment system for removal of metal contaminants from a fluid, comprising:
a reservoir;
a fluid treatment system; the fluid treatment system comprising a first vortex nozzle unit and a second vortex nozzle unit positioned in substantially opposed relation to the first vortex nozzle unit so that a fluid stream exiting the first vortex nozzle unit contacts a stream exiting the second vortex nozzle unit;
a conduit coupling an outlet of the reservoir to an inlet of the fluid treatment system; and
a fluid treatment conduit coupling an outlet of the fluid treatment system to the reservoir; and
wherein contacting the fluid stream exiting the first vortex nozzle unit with the fluid stream exiting the second vortex nozzle unit removes at least a portion of one or more metal contaminants from the fluid.

2. The system of claim 1, wherein the first vortex nozzle unit has a single vortex nozzle.

3. The system of claim 1, wherein at least one of the first vortex nozzle units has a plurality of vortex nozzles.

4. The system of claim 3, wherein the plurality of vortex nozzles are in a cascade configuration.

5. The system of claim 1, wherein the fluid treatment system is configured to enhance particulate growth of metal solids in the fluid stream.

6. The system of claim 1, further comprising an additive conduit configured to introduce additive to the reservoir, wherein the additive is configured to aid in forming metal precipitates.

7. The system of claim 1, further comprising an additive conduit coupled to at least one of the first vortex nozzle unit and the second vortex nozzle unit, wherein the additive conduit is configured to allow addition of an additive to the fluid stream as the fluid stream passes through the first and/or second vortex nozzle unit.

8. The system of claim 1, wherein at least one vortex nozzle unit comprises a vortex nozzle comprising a nozzle body including a passageway therethrough, a plurality of inlet ports, and an end cap attached to the nozzle body.

9. The system of claim 1, wherein a first portion of the fluid stream flows through a first set of nozzles and a second portion of the fluid stream flows through a second set of nozzles.

10. The system of claim 1, wherein one or more of the metal contaminates comprise heavy metals.

11. The system of claim 1, wherein at least one of the metal contaminates comprises aluminum.

12. The system of claim 1, wherein at least one of the metal contaminates comprises iron.

13. The system of claim 1, wherein at least one of the metal contaminates comprises manganese.

14. The system of claim 1, wherein at least one of the metal contaminates comprises lead.

15. The system of claim 1, wherein at least one of the metal contaminates comprises aluminum, arsenic, cadmium, chromium, copper, gold, iron, manganese, mercury, nickel, selenium, silver, tin, zinc, lead or mixtures thereof.

16. The system of claim 1, further comprising one or more separation units coupled to the reservoir, wherein the separation units are configured to remove metal particulates from the fluid.

17. The system of claim 1, further comprising one or more separation units coupled to the reservoir, wherein at least one of the separation units is a sedimentation unit.

18. A method for removing one or more metal contaminates from a fluid, comprising:
introducing a fluid stream to a reservoir; the fluid stream comprising one or more metal contaminates;
introducing a fluid stream to a fluid treatment system, the fluid treatment system comprising a first vortex nozzle unit and a second vortex nozzle unit positioned in substantially opposed relation to the first vortex nozzle unit;
flowing a first portion of the fluid stream through the first vortex nozzle unit;
flowing a second portion of the fluid stream through the second vortex nozzle unit; and
contacting the first portion of the fluid stream exiting the first vortex nozzle unit with the second portion of the fluid stream exiting the second vortex nozzle unit; and
wherein contacting the fluid stream exiting the first vortex nozzle unit with the fluid stream exiting the second vortex nozzle unit removes at least a portion of one or more of the metal contaminates in the fluid stream.

19. The method of claim 18, wherein the first vortex nozzle unit has a single vortex nozzle.

20. The method of claim 18, wherein at least one of the first vortex nozzle units has a plurality of vortex nozzles.

21. The method of claim 18, wherein the plurality of vortex nozzles are in a cascade configuration.

22. The method of claim 18, further comprising an additive conduit coupled to the first vortex nozzle unit, the method further comprises introducing one or more additives through the additive conduit.

23. The method of claim 18, wherein at least one of the first vortex nozzle unit comprises a units has a plurality of vortex nozzle comprising a nozzle body including a passageway therethrough, a plurality of inlet ports, and an end cap attached to the nozzle body. nozzles.

24. The method of claim 18, wherein the first vortex nozzle unit comprises a vortex nozzle comprising a nozzle body including a passageway therethrough, a plurality of inlet ports, and an end cap attached to the nozzle body.

25. The method of claim 18, wherein contacting the fluid stream exiting the first vortex nozzle unit with the fluid stream exiting the second vortex nozzle unit enhance particulate growth of one or metal containing solids in the fluid stream.

26. The method of claim 18, further comprising introducing one or more additives to the reservoir, wherein at least one of the additives forms a metal salt and/or metal complex with at least one of the metal contaminates in the fluid.

27. The method of claim 18, wherein one or more of the metal contaminates comprise heavy metals.

28. The method of claim 18, wherein at least one of the metal contaminates comprises aluminum.

29. The method of claim 18, wherein at least one of the metal contaminates comprises iron.

30. The method of claim 18, wherein at least one of the metal contaminates comprises manganese.

31. The method of claim 18, wherein at least one of the metal contaminates comprises lead.

32. The method of claim 18, wherein at least one of the metal contaminates comprises aluminum, arsenic, cadmium, chromium, copper, gold, iron, manganese, mercury, nickel, selenium, silver, tin, zinc, lead or mixtures thereof.

33. The method of claim 18, further comprising:
introducing at least a portion of the contacted fluid to one or more separation units coupled to the reservoir;
separating at least a portion of one or more metal contaminants in the fluid stream to form a fluid having a total concentration of heavy metals of at most 25 ppm; and
transporting the filtered fluid to one or more processing units, one or more storage units, one or more receiving bodies, or combinations thereof.
